(19) United States
(12) Patent Application Publication
(10) Pub. No.: US 2021/0231474 A1
(43) Pub. Date: Jul. 29, 2021

(54) DIFFERENTIAL PRESSURE TYPE FLOWMETER

(71) Applicant: Azbil Corporation, Tokyo (JP)

(72) Inventor: Kouji YUUKI, Tokyo (JP)

(21) Appl. No.: 17/151,244

(22) Filed: Jan. 18, 2021

(30) Foreign Application Priority Data
Jan. 23, 2020 (JP) 2020-008929

(51) Int. Cl. G01F 1/38; G01F 1/46; G01F 1/36

(52) U.S. Cl. CPC G01F 1/383; G01F 1/363; G01F 1/46

(57) ABSTRACT

Flow rate measurement errors are reduced by a differential flow type flowmeter that includes: a pipe; a laminar flow element disposed within the pipe; a differential pressure sensor that measures a differential pressure ΔP between an absolute pressure P1 of the fluid upstream of the laminar flow element and an absolute pressure P2 of the fluid downstream thereof; an absolute pressure sensor that measures the absolute pressure P2; and a flow rate calculation section that calculates a flow rate of the fluid on the basis of the differential pressure ΔP measured by the differential pressure sensor and the absolute pressure P2 measured by the absolute pressure sensor.

### CROSS REFERENCE TO RELATED APPLICATIONS

This patent application claims the benefit of foreign priority to Japanese Patent Application No. JP 2020-008929 filed on Jan. 23, 2020, the disclosure of which is hereby incorporated by reference in its entirety.

### BACKGROUND OF THE INVENTION

The present disclosure relates to a differential pressure type flowmeter such as a laminar flow type flowmeter.

A laminar flow type flowmeter is a flowmeter that uses a phenomenon in which a pressure drop accompanying a movement of a fluid is proportional to a volumetric flow rate in a case in which the fluid flows in a pipe in a laminar flow state (PTL 1 and PTL 2). A relationship between the fluid passing through a laminar flow element and a generated differential pressure ΔP is normally expressed by the following Equation.

Qm=ΔP×π×d⁴×ρ/(128×μ×L) (1)

In Equation (1), Qm denotes a mass flow rate, d denotes a flow path diameter of the laminar flow element, L denotes a flow path length of the laminar flow element, μ denotes a viscosity coefficient of the fluid, and ρ is a density of the fluid.

As illustrated in FIG. 9, the laminar flow type flowmeter has absolute pressure sensors 101 and 102 disposed upstream and downstream of a laminar flow element 100, respectively, and the laminar flow type flowmeter calculates the differential pressure ΔP generated when the fluid passes through the laminar flow element 100 by a difference (P1−P2) between an absolute pressure P1 measured by the absolute pressure sensor 101 and an absolute pressure P2 measured by the absolute pressure sensor 102.

As the laminar flow element, a type of laminar flow element in which sheet metals are stacked is widely used. In the laminar flow element of this type, flow paths of each rectangular cross-section can be formed by stacking different sheet metals on and under one sheet metal having a flow path opening portion formed by etching working or the like. This laminar flow element is characterized in that the flow paths at a uniform height are easy to produce, compared with ordinary working, since the height of one flow path depends on a thickness of one sheet metal. Furthermore, a flow rate range is easy to adjust by changing the number of stacked flow paths formed by the sheet metals.

In a case of the laminar flow type flowmeter illustrated in FIG. 9, use of the two absolute pressure sensors 101 and 102 and variations in characteristics of the individual absolute pressure sensors 101 and 102 cause flow rate measurement errors. That is, if measurement errors in the absolute pressures P1 and P2 are assumed as p1 and p2, respectively, a measurement error p3 in the differential pressure ΔP is expressed by the following square sum, which indicates that the measurement errors in the absolute pressure sensors 101 and 102 have a great influence on flow rate measurement accuracy.

[Expression 1]

p3=\sqrt{p1²+p2²} (2)

The above problems occur not only to the laminar flow type flowmeter but also similarly to differential pressure type flowmeters using an orifice plate, a pitot tube, and the like, each serving as a differential pressure generation mechanism.

### CITATION LIST

### Patent Literature

[PTL 1] Japanese Patent No. 4987977

[PTL 2] JP-A-2015-34762

### BRIEF SUMMARY OF THE INVENTION

The present disclosure has been achieved to solve the problems, and an object of the present disclosure is to provide a differential pressure type flowmeter capable of reducing flow rate measurement errors.

A differential pressure type flowmeter according to the present disclosure is characterized by including: a pipe circulating a fluid to be measured; a differential pressure generation mechanism that is installed within the pipe and that generates a differential pressure between the fluid on an upstream side and the fluid on a downstream side; a differential pressure sensor configured to measure a differential pressure between a first absolute pressure of the fluid upstream of the differential pressure generation mechanism and a second absolute pressure of the fluid downstream of the differential pressure generation mechanism; an absolute pressure sensor configured to measure the second absolute pressure; and a flow rate calculation section configured to calculate a flow rate of the fluid on the basis of the differential pressure measured by the differential pressure sensor and the second absolute pressure measured by the absolute pressure sensor.

Furthermore, a differential pressure type flowmeter according to the present disclosure is characterized by including: a pipe circulating a fluid to be measured; a laminar flow element that is installed within the pipe and that generates a differential pressure between the fluid on an upstream side and the fluid on a downstream side; a differential pressure sensor configured to measure a differential pressure between a first absolute pressure of the fluid within the laminar flow element and near an inlet, and a second absolute pressure of the fluid within the laminar flow element and near an outlet; an absolute pressure sensor configured to measure the second absolute pressure; and a flow rate calculation section configured to calculate a flow rate of the fluid on the basis of the differential pressure measured by the differential pressure sensor and the second absolute pressure measured by the absolute pressure sensor; and in that the laminar flow element includes an extraction port provided near the inlet for extracting the first absolute pressure, and an extraction port provided near the outlet for extracting the second absolute pressure.

Moreover, an example of configurations of the differential pressure type flowmeter according to the present disclosure is characterized in that the laminar flow element is formed from a structure in which first sheet metals and second sheet metals are alternately stacked in a direction orthogonal to a circulation direction of the fluid, a flow path of the fluid is formed in each of a plurality of the first sheet metals, each of a plurality of the second sheet metals includes: a first through-hole that is formed at a position of communicating with a portion near the inlet of the flow path in such a manner as to penetrate each second sheet metal from a rear surface to a front surface; and a second through-hole that is formed at a position of communicating with a portion near the outlet of the flow path in such a manner as to penetrate each second sheet metal from the rear surface to the front surface, the extraction port for extracting the first absolute pressure is provided in such a manner as to communicate with the first through-hole in the second sheet metal located on an outermost side in a stacking direction, and the extraction port for extracting the second absolute pressure is provided in such a manner as to communicate with the second through-hole in the second sheet metal located on the outermost side in the stacking direction.

Furthermore, an example of configurations of the differential pressure type flowmeter according to the present disclosure is characterized in that the flow rate calculation section calculates the flow rate of the fluid from the differential pressure measured by the differential pressure sensor using a flow rate conversion equation corresponding to the second absolute pressure measured by the absolute pressure sensor out of the flow rate conversion equation prepared per second absolute pressure in advance.

Moreover, a differential pressure type flowmeter according to the present disclosure is characterized by including: a pipe circulating a fluid to be measured; a differential pressure generation mechanism that is installed within the pipe and that generates a differential pressure between the fluid on an upstream side and the fluid on a downstream side; a differential pressure sensor configured to measure a differential pressure between a first absolute pressure of the fluid upstream of the differential pressure generation mechanism and a second absolute pressure of the fluid downstream of the differential pressure generation mechanism; an absolute pressure sensor configured to measure the first absolute pressure; and a flow rate calculation section configured to calculate a flow rate of the fluid on the basis of the differential pressure measured by the differential pressure sensor and the first absolute pressure measured by the absolute pressure sensor.

Furthermore, a differential pressure type flowmeter according to the present disclosure is characterized by including: a pipe circulating a fluid to be measured; a laminar flow element that is installed within the pipe and that generates a differential pressure between the fluid on an upstream side and the fluid on the downstream side; a differential pressure sensor configured to measure a differential pressure between a first absolute pressure of the fluid within the laminar flow element and near an inlet, and a second absolute pressure of the fluid within the laminar flow element and near an outlet; an absolute pressure sensor configured to measure the first absolute pressure; and a flow rate calculation section configured to calculate a flow rate of the fluid on the basis of the differential pressure measured by the differential pressure sensor and the first absolute pressure measured by the absolute pressure sensor; and in that the laminar flow element includes: an extraction port provided near the inlet for extracting the first absolute pressure; and an extraction port provided near the outlet for extracting the second absolute pressure.

Moreover, an example of configurations of the differential pressure type flowmeter according to the present disclosure is characterized in that the flow rate calculation section calculates the second absolute pressure by a difference between the differential pressure measured by the differential pressure sensor and the first absolute pressure measured by the absolute pressure sensor, and calculates the flow rate of the fluid from the differential pressure measured by the differential pressure sensor using a flow rate conversion equation corresponding to the calculated second absolute pressure out of the flow rate conversion equation prepared per second absolute pressure in advance.

According to the present disclosure, it is possible to reduce flow rate measurement errors by measuring the differential pressure between the first absolute pressure of the fluid upstream of the differential pressure generation mechanism and the second absolute pressure of the fluid downstream thereof. In addition, according to the present disclosure, it is possible to calculate the flow rate of the fluid more accurately by using not only the differential pressure sensor but also the absolute pressure sensor that measures either the second absolute pressure or the first absolute pressure.

Furthermore, according to the present disclosure, it is possible to measure either the first absolute pressure or the second absolute pressure and the differential pressure, and ensure more accurate flow rate measurement without the influence of the inlet pressure loss and the outlet pressure loss of the laminar flow element by using, as the differential pressure generation mechanism, the laminar flow element configured with the first absolute pressure extraction port near the inlet and the second absolute pressure extraction port near the outlet.

### BRIEF DESCRIPTION OF THE SEVERAL VIEWS OF THE DRAWING

FIG. 1 is a diagram illustrating configurations of a laminar flow type flowmeter according to a first embodiment of the present disclosure.

FIG. 2 is a diagram illustrating an example of a relationship between a flow rate of a fluid and a differential pressure between the fluid on an upstream side and the fluid on a downstream side when a pressure of the fluid on the downstream side is changed in the laminar flow type flowmeter.

FIG. 3 is an exploded perspective view of a laminar flow element in the laminar flow type flowmeter according to the first embodiment of the present disclosure.

FIG. 4 is a perspective view of the laminar flow element in the laminar flow type flowmeter according to the first embodiment of the present disclosure.

FIG. 5 is a diagram illustrating other configurations of the laminar flow type flowmeter according to the first embodiment of the present disclosure.

FIG. 6 is a diagram illustrating configurations of a laminar flow type flowmeter according to a second embodiment of the present disclosure.

FIG. 7 is a diagram illustrating other configurations of the laminar flow type flowmeter according to the second embodiment of the present disclosure.

FIG. 8 is a block diagram illustrating an example of configurations of a computer that realizes the laminar flow type flowmeters according to the first and second embodiments of the present disclosure.

FIG. 9 is a diagram illustrating configurations of a conventional laminar flow type flowmeter.

### DETAILED DESCRIPTION OF THE INVENTION

### First Embodiment

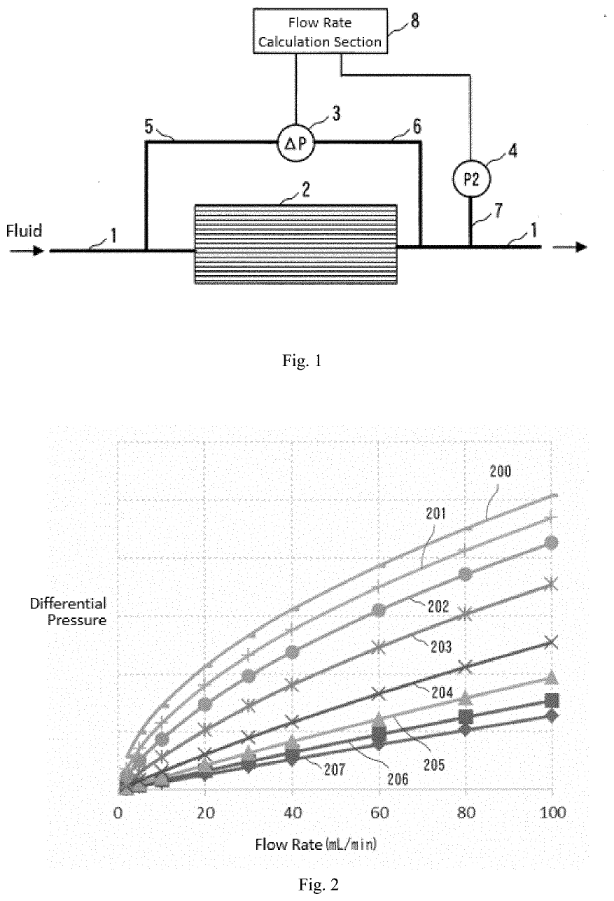

Embodiments of the present disclosure will be described below with reference to the drawings. FIG. 1 is a diagram illustrating configurations of a laminar flow type flowmeter (differential pressure type flowmeter) according to a first embodiment of the present disclosure. The laminar flow type flowmeter is configured with a pipe 1 circulating a fluid to be measured, a laminar flow element 2 installed within the pipe 1 and serving as a differential pressure generation mechanism that generates a differential pressure between the fluid on an upstream side and the fluid on a downstream side, a differential pressure sensor 3 that measures a differential pressure ΔP between an absolute pressure P1 of the fluid upstream of the laminar flow element 2 and an absolute pressure P2 of the fluid downstream thereof, an absolute pressure sensor 4 that measures the absolute pressure P2, conduits 5 and 6 that guide the fluid to the differential pressure sensor 3, a conduit 7 that guides the fluid to the absolute pressure sensor 4, and a flow rate calculation section 8 that calculates a flow rate of the fluid on the basis of the differential pressure ΔP measured by the differential pressure sensor 3 and the absolute pressure P2 measured by the absolute pressure sensor 4.

Examples of the differential pressure sensor 3 and the absolute pressure sensor 4 include a semiconductor piezoresistance type pressure sensor and a capacitance type pressure sensor.

In the present embodiment, measuring the differential pressure ΔP of the fluid generated in the laminar flow element 2 by one differential pressure sensor 3 makes it possible to reduce flow rate measurement errors, compared with a case of using two absolute pressure sensors as in the conventional technique.

Furthermore, a viscosity and a density of the fluid change with a change in a pressure of the fluid downstream of the laminar flow element 2; thus, a relationship between the flow rate and the differential pressure ΔP changes as illustrated in, for example, FIG. 2. Owing to this, it is possible to accurately calculate the relationship between the flow rate and the differential pressure ΔP by accurately measuring the absolute pressure P2 of the fluid on the downstream side by the absolute pressure sensor 4. In FIG. 2, 200, 201, 202, 203, 204, 205, 206, and 207 indicate the relationship between the flow rate and the differential pressure ΔP when the absolute pressure P2 is 1 kPaA, 5 kPaA, 10 kPaA, 20 kPaA, 40 kPaA, 60 kPaA, 80 kPaA, and 100 kPaA, respectively.

A flow rate conversion equation for converting the differential pressure ΔP into the flow rate Q is registered in the flow rate calculation section 8 according to the present embodiment per absolute pressure P2 of the fluid on the downstream side in advance. The flow rate calculation section 8 calculates a value of the flow rate Q of the fluid from the differential pressure ΔP measured by the differential pressure sensor 3 using the flow rate conversion equation corresponding to the absolute pressure P2 measured by the absolute pressure sensor 4. Since the mass flow rate Qm can be calculated from the differential pressure ΔP as expressed by Equation (1), it is possible to obtain the flow rate Q (volumetric flow rate) from the mass flow rate Qm. The flow rate conversion equation per absolute pressure P2 is an equation for which, for example, values of the viscosity coefficient and the density included in the equation are changed individually to correspond to the absolute pressure P2.

Thus, by measuring the differential pressure ΔP by one differential pressure sensor 3, it is possible to reduce flow rate measurement errors of the laminar flow type flowmeter in the present embodiment.

While it is necessary to guide the fluid flowing in the pipe 1 to the differential pressure sensor 3 and the absolute pressure sensor 4 via the conduits 5 to 7, presence of an inlet pressure loss and an outlet pressure loss of the laminar flow element 2 possibly causes a reduction in flow rate measurement accuracy.

To address the possible reduction, the flow rate may be measured more accurately using the following laminar flow element.

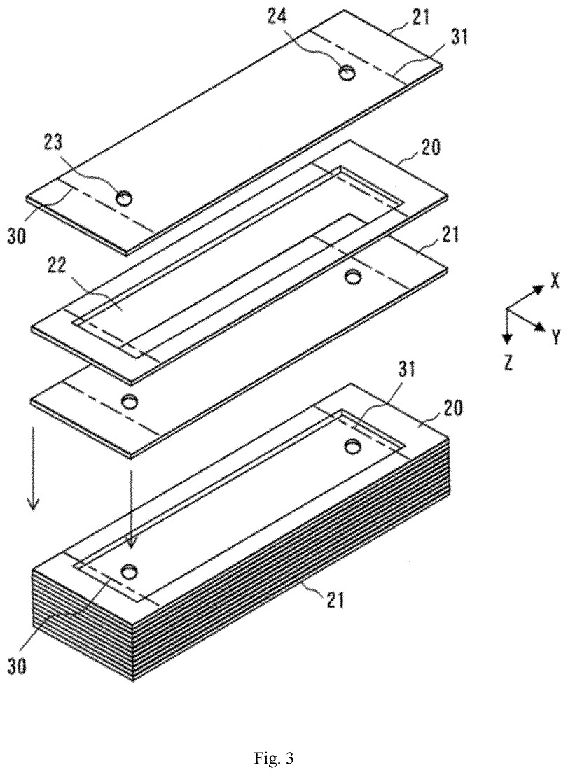

FIG. 3 is an exploded perspective view of the laminar flow element 2. It is assumed herein that a fluid circulation direction is an X-direction, a direction of stacking sheet metals to be described later is a Z-direction, and a direction orthogonal to the Z-direction and the X-direction is a Y direction. In FIG. 3, 20 and 21 are sheet metals formed from, for example, a stainless steel and identical in size. A flow path rectangular opening portion 22 is formed in the sheet metal 20 (first thin sheet). Through-holes 23 and 24 penetrating each sheet metal 21 from a rear surface to a front surface are formed near two end portions of the sheet metal 21 in the fluid circulation direction (X-direction). It is to be noted, however, that the through-holes 23 and 24 are not formed in the sheet metal 21 that serves as a lowermost layer at a time of alternately stacking the sheet metals 20 and 21, as described later.

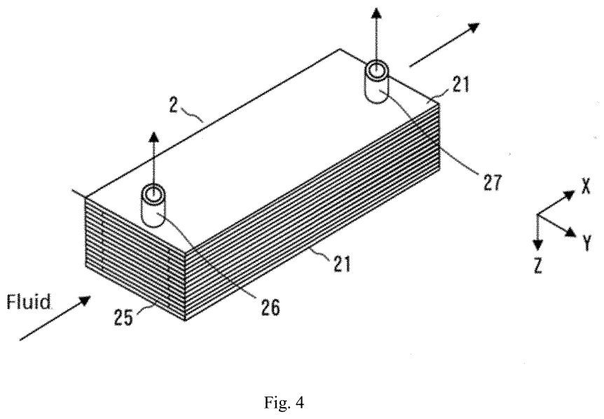

Pluralities of such sheet metals 20 and 21 are alternately superimposed and the adjacent sheet metals 20 and 21 are fixed by, for example, brazing. A structure of stacking the sheet metals 20 and 21 is then cut off at positions slightly inward of two end portions of the opening portion 22. In FIG. 3, 30 and 31 indicate cut-off positions. A structure of the laminar flow element 2 is thereby completed as illustrated in FIG. 4. A space having a rectangular cross-section with two ends in the fluid circulation direction (X-direction) opened is formed in each sheet metal 20 by the cut-off described above. This space acts as a flow path 25. That is, a plurality of flow paths 25 are formed in the laminar flow element 2.

Moreover, forming the through-holes 23 in all the sheet metals 21 but the lowermost sheet metal 21 enables the through-holes 23 to be disposed to communicate with portions near inlets of the flow paths 25. Furthermore, the through-holes 24 are disposed to communicate with portions near outlets of the flow paths 25.

Furthermore, an absolute pressure P1 extraction port 26 is attached to the sheet metal 21 located on an outermost side in the stacking direction (uppermost sheet metal 21 in the example of FIG. 4) in such a manner as to communicate with the through-holes 23, and an absolute pressure P2 extraction port 27 is attached to the same sheet metal 21 in such a manner as to communicate with the through-holes 24.

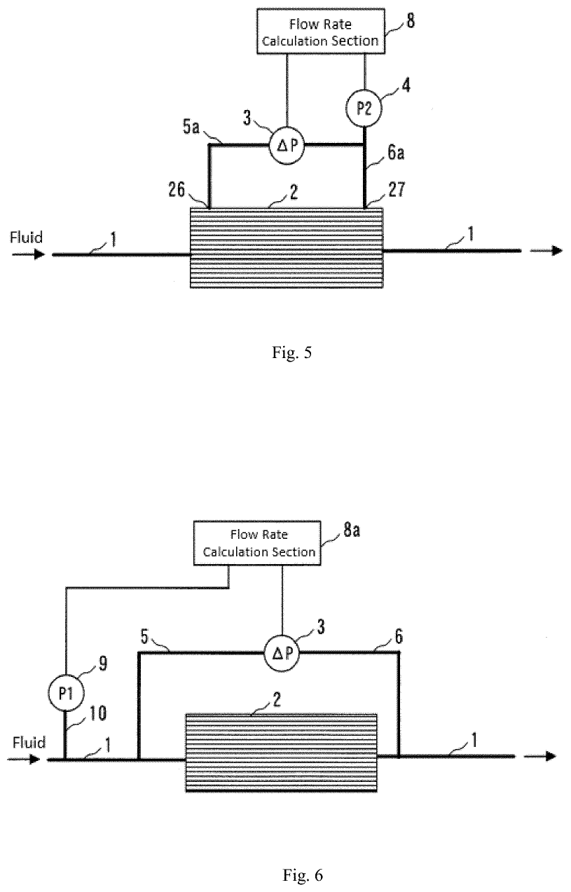

FIG. 5 illustrates configurations of a laminar flow type flowmeter in a case of applying the laminar flow element 2 of FIG. 4 to the laminar flow type flowmeter. A conduit 5a is connected to the extraction port 26 closer to an inlet of the laminar flow element 2, and a conduit 6a is connected to the extraction port 27 closer to an outlet thereof. The conduit 5a guides the fluid within the laminar flow element 2 and near the inlet to the differential pressure sensor 3. The conduit 6a guides the fluid within the laminar flow element 2 and near the outlet to the differential pressure sensor 3 and the absolute pressure sensor 4.

Thus, with the configurations illustrated in FIGS. 4 and 5, the pressure P1 of the fluid within the laminar flow element 2 and near the inlet and the pressure P2 of the fluid within the laminar flow element 2 and near the outlet can be extracted; therefore, it is possible to measure the differential pressure ΔP=P1−P2 and the absolute pressure P2 without an influence of the inlet pressure loss and the outlet pressure loss of the laminar flow element 2, and to ensure more accurate flow rate measurement.

### Second Embodiment

A second embodiment of the present disclosure will next be described. FIG. 6 is a diagram illustrating configurations of a laminar flow type flowmeter (differential pressure type flowmeter) according to the second embodiment of the present disclosure. The laminar flow type flowmeter is configured with the pipe 1, the laminar flow element 2, the differential pressure sensor 3, an absolute pressure sensor 9 that measures the absolute pressure P1 of the fluid upstream of the laminar flow element 2, the conduits 5 and 6, a conduit 10 that guides the fluid to the absolute pressure sensor 9, and a flow rate calculation section 8a that calculates a flow rate of the fluid on the basis of the differential pressure ΔP measured by the differential pressure sensor 3 and the absolute pressure P1 measured by the absolute pressure sensor 9.

Similarly to the absolute pressure sensor 4, examples of the absolute pressure sensor 9 include a semiconductor piezoresistance type pressure sensor and a capacitance type pressure sensor.

The flow rate calculation section 8a in the present embodiment calculates the absolute pressure P2 of the fluid downstream of the laminar flow element 2 by the difference between the differential pressure ΔP measured by the differential pressure sensor 3 and the absolute pressure P1 measured by the absolute pressure sensor 9.

P2=P1−ΔP (3)

Similarly to the first embodiment, the flow rate conversion equation for converting the differential pressure ΔP into the flow rate Q is registered in the flow rate calculation section 8a per absolute pressure P2 of the fluid on the downstream side in advance. The flow rate calculation section 8a calculates the value of the flow rate Q of the fluid from the differential pressure ΔP measured by the differential pressure sensor 3 using the flow rate conversion equation corresponding to the calculated absolute pressure P2.

Thus, in the present embodiment, it is possible to obtain similar advantages to those of the first embodiment. It is to be noted, however, that the first embodiment in which the absolute pressure P2 of the downstream side is directly measured can obtain more desired advantages since measurement errors in the absolute pressure P1 occur in the second embodiment.

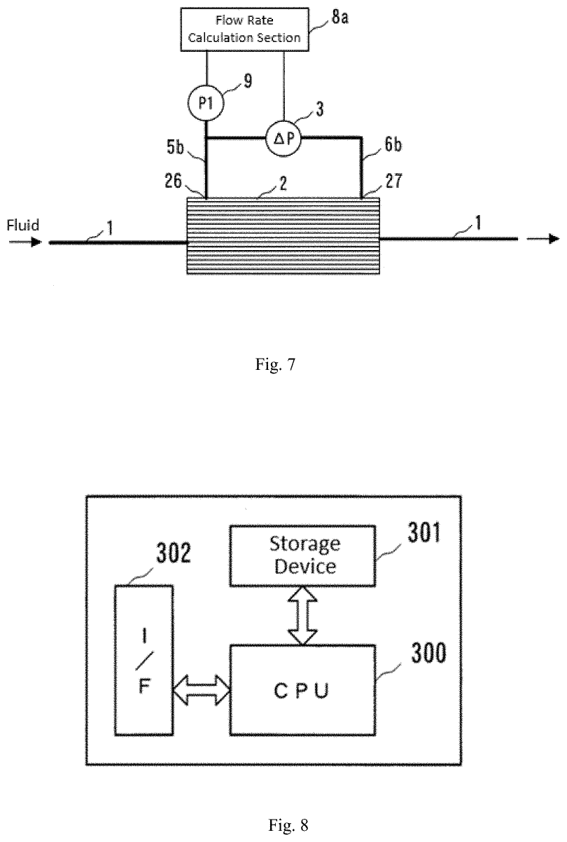

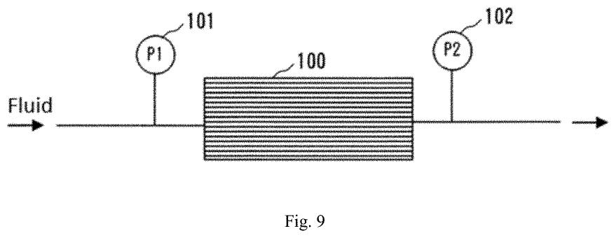

FIG. 7 illustrates configurations of a laminar flow type flowmeter in a case of applying the laminar flow element 2 described with reference to FIG. 4 to the present embodiment. A conduit 5b is connected to the extraction port 26 closer to the inlet of the laminar flow element 2, and a conduit 6b is connected to the extraction port 27 closer to the outlet thereof. The conduit 5b guides the fluid within the laminar flow element 2 and near the inlet to the differential pressure sensor 3 and the absolute pressure sensor 9. The conduit 6b guides the fluid within the laminar flow element 2 and near the outlet to the differential pressure sensor 3.

Thus, with the configurations illustrated in FIG. 7, using the laminar flow element 2 described with reference to FIG. 4 makes it possible to measure the differential pressure ΔP and the absolute pressure P1 and to ensure more accurate flow rate measurement without the influence of the inlet pressure loss and the outlet pressure loss of the laminar flow element 2.

While the laminar flow element 2 is used as the differential pressure generation mechanism in the first and second embodiments, other differential pressure generation mechanisms may be used such as an orifice plate or a pitot tube.

Needless to say, for the configurations illustrated in FIGS. 5 and 7, the laminar flow element 2 described with reference to FIG. 4 is necessary.

The flow rate calculation sections 8 and 8a described in the first and second embodiments can each be realized by a computer configured with a CPU (Central Processing Unit), a storage device, and an interface, and a program that controls hardware resources of these constituent elements. FIG. 8 illustrates an example of configurations of this computer. The computer is configured with a CPU 300, a storage device 301, and an interface device (I/F) 302. Circuits of the sensors 3, 4, and 9 and the like are connected to the I/F 302. A program for realizing a flow rate measurement method according to the present disclosure is stored in the storage device 301. The CPU 300 executes the processing described in the first and second embodiments in accordance with the program stored in the storage device 301.

The present disclosure is applicable to a differential pressure type flowmeter.

### DESCRIPTION OF REFERENCE NUMERALS AND SIGNS

1: pipe, 2: laminar flow element, 3: differential pressure sensor, 4, 9: absolute pressure sensor, 5, 5a, 5b, 6, 6a, 6b, 7, 10: conduit, 8, 8a: flow rate calculation section, 20, 21: sheet metal, 23, 24: through-hole, 25: flow path, 26, 27: extraction port

1. A differential pressure type flowmeter comprising:
a pipe configured to circulate a fluid to be measured;
a differential pressure generation mechanism that is installed within the pipe and that is configured to generate a differential pressure between the fluid on an upstream side and the fluid on a downstream side;
a differential pressure sensor configured to measure a differential pressure between a first absolute pressure of the fluid upstream of the differential pressure generation mechanism and a second absolute pressure of the fluid downstream of the differential pressure generation mechanism;
an absolute pressure sensor configured to measure the second absolute pressure; and
a flow rate calculation section configured to calculate a flow rate of the fluid on the basis of the differential pressure measured by the differential pressure sensor and the second absolute pressure measured by the absolute pressure sensor.

2. A differential pressure type flowmeter comprising:
a pipe configured to circulate a fluid to be measured;
a laminar flow element that is installed within the pipe and that is configured to generate a differential pressure between the fluid on an upstream side and the fluid on a downstream side;
a differential pressure sensor configured to measure a differential pressure between a first absolute pressure of the fluid within the laminar flow element and near an inlet and a second absolute pressure of the fluid within the laminar flow element and near an outlet;
an absolute pressure sensor configured to measure the second absolute pressure; and
a flow rate calculation section configured to calculate a flow rate of the fluid on the basis of the differential pressure measured by the differential pressure sensor and the second absolute pressure measured by the absolute pressure sensor;
wherein the laminar flow element includes an extraction port provided near the inlet for extracting the first absolute pressure, and an extraction port provided near the outlet for extracting the second absolute pressure.

3. The differential pressure type flowmeter according to claim 2, wherein
the laminar flow element is formed from a structure in which first sheet metals and second sheet metals are alternately stacked in a direction orthogonal to a circulation direction of the fluid,
a flow path of the fluid is formed in each of a plurality of the first sheet metals,
each of a plurality of the second sheet metals includes: a first through-hole that is formed at a position of communicating with a portion near the inlet of the flow path in such a manner as to penetrate each second sheet metal from a rear surface to a front surface; and a second through-hole that is formed at a position of communicating with a portion near the outlet of the flow path in such a manner as to penetrate each second sheet metal from the rear surface to the front surface,
the extraction port for extracting the first absolute pressure is provided in such a manner as to communicate with the first through-hole in the second sheet metal located on an outermost side in a stacking direction, and
the extraction port for extracting the second absolute pressure is provided in such a manner as to communicate with the second through-hole in the second sheet metal located on the outermost side in the stacking direction.

4. The differential pressure type flowmeter according to claim 1, wherein
the flow rate calculation section calculates the flow rate of the fluid from the differential pressure measured by the differential pressure sensor using a flow rate conversion equation corresponding to the second absolute pressure measured by the absolute pressure sensor out of the flow rate conversion equation prepared per second absolute pressure in advance.

5. The differential pressure type flowmeter according to claim 2, wherein
the flow rate calculation section calculates the flow rate of the fluid from the differential pressure measured by the differential pressure sensor using a flow rate conversion equation corresponding to the second absolute pressure measured by the absolute pressure sensor out of the flow rate conversion equation prepared per second absolute pressure in advance.

6. The differential pressure type flowmeter according to claim 3, wherein
the flow rate calculation section calculates the flow rate of the fluid from the differential pressure measured by the differential pressure sensor using a flow rate conversion equation corresponding to the second absolute pressure measured by the absolute pressure sensor out of the flow rate conversion equation prepared per second absolute pressure in advance.

7. A differential pressure type flowmeter comprising:
a pipe configured to circulate a fluid to be measured;
a differential pressure generation mechanism that is installed within the pipe and that is configured to generate a differential pressure between the fluid on an upstream side and the fluid on a downstream side;
a differential pressure sensor configured to measure a differential pressure between a first absolute pressure of the fluid upstream of the differential pressure generation mechanism and a second absolute pressure of the fluid downstream of the differential pressure generation mechanism;
an absolute pressure sensor configured to measure the first absolute pressure; and
a flow rate calculation section configured to calculate a flow rate of the fluid on the basis of the differential pressure measured by the differential pressure sensor and the first absolute pressure measured by the absolute pressure sensor.

8. A differential pressure type flowmeter comprising:
a pipe configured to circulate a fluid to be measured;
a laminar flow element that is installed within the pipe and that is configured to generate a differential pressure between the fluid on an upstream side and the fluid on a downstream side;
a differential pressure sensor configured to measure a differential pressure between a first absolute pressure of the fluid within the laminar flow element and near an inlet and a second absolute pressure of the fluid within the laminar flow element and near an outlet;
an absolute pressure sensor configured to measure the first absolute pressure; and
a flow rate calculation section configured to calculate a flow rate of the fluid on the basis of the differential pressure measured by the differential pressure sensor and the first absolute pressure measured by the absolute pressure sensor;
wherein the laminar flow element includes: an extraction port provided near the inlet for extracting the first absolute pressure; and an extraction port provided near the outlet for extracting the second absolute pressure.

9. The differential pressure type flowmeter according to claim 8, wherein
the laminar flow element is formed from a structure in which first sheet metals and second sheet metals are alternately stacked in a direction orthogonal to a circulation direction of the fluid,
a flow path of the fluid is formed in each of a plurality of the first sheet metals,
each of a plurality of the second sheet metals includes: a first through-hole that is formed at a position of communicating with a portion near the inlet of the flow path in such a manner as to penetrate each second sheet metal from a rear surface to a front surface; and a second through-hole that is formed at a position of communicating with a portion near the outlet of the flow path in such a manner as to penetrate each second sheet metal from the rear surface to the front surface,
the extraction port for extracting the first absolute pressure is provided in such a manner as to communicate with the first through-hole in the second sheet metal located on an outermost side in a stacking direction, and
the extraction port for extracting the second absolute pressure is provided in such a manner as to communicate with the second through-hole in the second sheet metal located on the outermost side in the stacking direction.

10. The differential pressure type flowmeter according to claim 7, wherein
the flow rate calculation section calculates the second absolute pressure by a difference between the differential pressure measured by the differential pressure sensor and the first absolute pressure measured by the absolute pressure sensor, and calculates the flow rate of the fluid from the differential pressure measured by the differential pressure sensor using a flow rate conversion equation corresponding to the calculated second absolute pressure out of the flow rate conversion equation prepared per second absolute pressure in advance.

11. The differential pressure type flowmeter according to claim 8, wherein
the flow rate calculation section calculates the second absolute pressure by a difference between the differential pressure measured by the differential pressure sensor and the first absolute pressure measured by the absolute pressure sensor, and calculates the flow rate of the fluid from the differential pressure measured by the differential pressure sensor using a flow rate conversion equation corresponding to the calculated second absolute pressure out of the flow rate conversion equation prepared per second absolute pressure in advance.

12. The differential pressure type flowmeter according to claim 9, wherein
the flow rate calculation section calculates the second absolute pressure by a difference between the differential pressure measured by the differential pressure sensor and the first absolute pressure measured by the absolute pressure sensor, and calculates the flow rate of the fluid from the differential pressure measured by the differential pressure sensor using a flow rate conversion equation corresponding to the calculated second absolute pressure out of the flow rate conversion equation prepared per second absolute pressure in advance.
